(19) United States
(12) Patent Application Publication
(10) Pub. No.: US 2025/0011607 A1
(43) Pub. Date: Jan. 9, 2025

(54) Silicone Resin, Coating Composition Comprising Same, and Cured Product Thereof

(71) Applicant: DONGJIN SEMICHEM CO., LTD., Incheon (KR)

(72) Inventors: Woo Seung SHIN, Seongnam-si, Gyeonggi-do (KR); Dong Jin NAM, Seongnam-si, Gyeonggi-do (KR); Seong Yeon OH, Seongnam-si, Gyeonggi-do (KR); Kook Hee LIM, Seongnam-si, Gyeonggi-do (KR); Jai Young CHUNG, Seongnam-si, Gyeonggi-do (KR); Seung Sock CHOI, Seongnam-si, Gyeonggi-do (KR); Han Bin PARK, Seongnam-si, Gyeonggi-do (KR)

(21) Appl. No.: 18/749,306

(22) Filed: Jun. 20, 2024

Related U.S. Application Data
(63) Continuation of application No. PCT/KR2022/021241, filed on Dec. 23, 2022.

(30) Foreign Application Priority Data
Dec. 29, 2021 (KR) 10-2021-0191252

(51) Int. Cl. C09D 7/62; C08G 77/04; C08G 77/18; C08K 9/08; C09D 7/40; C09D 183/06

(52) U.S. Cl. CPC C09D 7/62; C08G 77/045; C08G 77/18; C08K 9/08; C09D 7/67; C09D 7/68; C09D 7/70; C09D 183/06; C08K 2201/005; C08K 2201/006; C08K 2201/011

(57) ABSTRACT

A silicone resin includes a hollow silica structure and a silsesquioxane structure bonded to the hollow silica structure. A hydroxy group is included in an amount of 1.0 wt % or less relative to the total weight of the silicone resin, thereby being able to realize a low refractive index and an excellent coating property. A coating composition contains the silicone resin, and high solution stability is achieved even without a separate dispersion process. A product is cured from the coating composition.

### CROSS-REFERENCE TO RELATED APPLICATION

This application is a Continuation of International Application No. PCT/KR2022/021241 filed Dec. 23, 2022, which claims priority from Korean Application No. 10-2021-0191252 filed Dec. 29, 2021. The aforementioned applications are incorporated herein by reference in their entireties.

### TECHNICAL FIELD

The present disclosure relates to a silicone resin, a coating composition containing the same, and a cured product thereof.

### RELATED ART

Recently, the display market has been rapidly changing with thin filming processes, flexibility, and enlargement, and these products have entered the stage of being realized. The enlargement of the display is undergoing a change from the existing dry process to a wet process capable of continuous processing, and the thin filming processes and flexibility of the display are changing the materials applied to the display. In particular, the thick glass material applied to the outermost shell is being replaced with a thin film or plastic material. Accordingly, in order to overcome the optical properties and surface properties of thinned glass or plastic materials, the importance of coating materials has been also raised.

In addition to the above reasons, studies have been actively conducted on coating materials that can protect the surface of a large-area display and reduce the reflectance of external light to thereby realize a clear image of the display.

In Korean Patent Application Publication No. 10-2016-0023476A, a coating layer with a low refractive index in which an acrylic resin and hollow silica are mixed was formed on a polyester film to improve transmittance of the substrate. However, in the above-identified patent application, although the light transmittance is improved along with the refractive index control due to the hollow silica content, there is a problem in that the adhesion and scratch resistance are deteriorated. In addition, the simple mixing of the acrylic resin and the hollow silica has a problem in that a decrease in the dispersibility of the hollow silica causes issues in relation to coating properties and stability of the coating solution.

### SUMMARY

In order to solve the above problems, an object of the present invention is to provide a silicone resin, which has excellent light transmittance with refractive index control and excellent coatability and stability when included in a coating composition.

Another object of the present invention is to provide a coating composition, which, by including the silicone resin, has excellent coatability and stability along with a low refractive index and high light transmittance.

Still another object of the present invention is to provide a cured product of the coating composition.

In order to achieve the above objects, the silicone resin according to an embodiment of the present invention includes a hollow silica structure and a silsesquioxane structure bonded to the hollow silica structure, in which a hydroxy group is included in an amount of 1.0 wt % or less relative to the total weight of the silicone resin.

The silsesquioxane structure may be a ladder-type silsesquioxane structure.

The silicone resin may have a BET specific surface area of 500 m²/g to 2,000 m²/g.

The silicone resin may include 20 wt % to 50 wt % of the hollow silica structure relative to the weight of the silicone resin.

In particular, the hollow silica structure may have a porosity of 5 vol % to 80 vol %.

Moreover, the silicone resin may have a density of 0.5 g/mL to 1.8 g/mL.

The hollow silica structure may have a size of 10 nm to 500 nm.

The silsesquioxane structure may have the repeating unit of Formula 1 below.

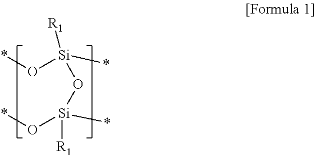

In Formula 1 above, R₁ is each independently a substituted or unsubstituted C₁-C₃₀ alkyl group, a substituted or unsubstituted C₁-C₃₀ aryl group, a fluorine-containing C₁-C₃₀ organic group, an acryl group, a methacryl group, an epoxy group, a cyclohexylepoxy group, a peroxide group, a hydroperoxide group, a thiol group, an isocyanate group, an unsaturated hydrocarbon group, an azide group, an amine group, a carboxyl group, a nitrile group, or a nitro group.

In particular, the silsesquioxane structure may further include the repeating unit of Formula 2 below.

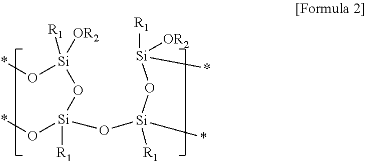

In Formula 2 above, R₁ is each independently a substituted or unsubstituted C₁-C₃₀ alkyl group, a substituted or unsubstituted C₁-C₃₀ aryl group, a fluorine-containing C₁-C₃₀ organic group, an acryl group, a methacryl group, an epoxy group, a cyclohexylepoxy group, a peroxide group, a hydroperoxide group, a thiol group, an isocyanate group, an unsaturated hydrocarbon group, an azide group, an amine group, a carboxyl group, a nitrile group, or a nitro group; and R₂ is each independently hydrogen or a substituted or unsubstituted C₁-C₃₀ alkyl group.

The silicone resin may include one or more curable functional groups between a thermosetting functional group and a photocurable functional group, in which the curable functional group may be included in the silsesquioxane structure and the silsesquioxane structure may include 5 wt % to 40 wt % of the curable functional group.

The curable functional group may include one or more functional groups from the group consisting of an acryl group, a methacryl group, an epoxy group, a cyclohexylepoxy group, a peroxide group, a hydroperoxide group, a thiol group, an isocyanate group, an unsaturated hydrocarbon group, an azide group, an amine group, a carboxyl group, a nitrile group, and a nitro group.

The silicone resin may be one which is polymerized by including an alkoxysilane or an oligomer derived from an alkoxysilane; and hollow silica having a surface functional group, and may be one in which the hollow silica structure and the silsesquioxane structure are siloxane-bonded.

A coating composition according to another embodiment of the present invention includes the silicone resin and a solvent.

The solvent may include a fluorine-based solvent.

A cured product according to still another embodiment of the present invention is cured from the coating composition.

The cured product may have a refractive index of 1.05 to 1.45.

The cured product may have a pencil hardness of 2H or higher.

The silicone resin according to the present invention, by including the hollow silica structure inside the resin structure, can achieve a low refractive index, excellent coatability, and high solution stability even without a separate dispersion process.

### DETAILED DESCRIPTION

The terms or words used in this specification and claims should not be construed as being limited to ordinary or dictionary meanings, but should be interpreted as meanings and concepts consistent with the technical idea of the present invention based on the principle that the concept of these terms can be appropriately defined in order to explain their invention in the best way.

Therefore, the constitutions illustrated in the embodiments and preparation examples described in this specification are merely one of exemplary embodiments of the present invention, and do not represent all of the technical spirit of the present invention; therefore, it should be understood that there may be many equivalents and variations that can replace these at the time of the present application.

Additionally, as used herein, “*” means a part connected to the same or different atom or formula.

Hereinafter, embodiments of the present invention will be described in detail so that those skilled in the art can easily realize the present invention. However, the present invention can be realized in many different forms and is not limited to the Preparation Examples and Examples described herein.

The silicone resin according to an embodiment of the present invention includes a hollow silica structure and a silsesquioxane structure bonded to the surface of the hollow silica structure, which is characterized in that the silicone resin includes a small proportion of a hydroxy group to be 1.0 wt % or less relative to the total weight of the silicone resin.

In order for the hollow silica structure to bind to a silsesquioxane structure, it is necessary to have a surface functional group on the surface of the hollow silica structure before bonding, and the surface functional group may be, for example, a hydroxy group. However, if a hydroxy group exists even after the hollow silica structure and the silsesquioxane structure are bonded, the hydroxy group significantly reduces the solubility of the silicone resin in an organic solvent, and gelation phenomenon occurs due to condensation between the hydroxy groups thereby reducing stability; therefore, it is preferred to minimize hydroxy groups in the silicon resin. In the silicone resin according to an embodiment of the present invention, most of the hydroxy groups present on the surface of the hollow silica structure are bonded to the silsesquioxane structure, and the silicone resin, while including a form where the hollow silica structure is chemically bonded to the silsesquioxane structure, exhibits a low content of hydroxy groups, and specifically includes a content of hydroxy groups that is 1.0 wt % or less relative to the total weight of the silicone resin. When the content of the hydroxy group in the silicone resin exceeds 1.0 wt %, the solubility in an organic solvent may be reduced, and the gelation phenomenon occurs due to the condensation between the hydroxy groups thereby significantly reducing stability. Furthermore, in order to provide excellent solubility of the silicone resin in organic solvents and improve its long-term reliability (stability), it may be more preferable that the hydroxy group content of the silicone resin be 0.5 wt % or less, and the hydroxy group content of the silicone resin can be confirmed using infrared spectroscopy (IR).

The structure of silsesquioxane bonded to the surface of the hollow silica structure in the silicone resin may include a random-like or cage-like structure, but one including a ladder-like silsesquioxane structure may be preferred. When the structure of silsesquioxane is ladder-shaped, its solubility is excellent compared to other structures of silsesquioxane due to its linear characteristic, and compatibility with other compositions of the coating composition may be expressed excellently when it is included in a coating composition. The ladder-type silsesquioxane structure is structurally rigid due to a double regular siloxane bond, thus having the advantage of spontaneous thermal curing of a random-type structure through hydroxy and alkoxy groups at the ends or side chains as well as enabling the realization of high surface hardness comparable to a cage-type structure.

When a coating composition is formed by merely mixing hollow silica with already-polymerized silsesquioxane, a chemical bond is formed between silsesquioxane and hollow silica only after undergoing a curing process, and even if a chemical bond is formed, the ratio is insignificant and thus the content of hydroxy groups remaining on the surface of the hollow silica is high. Additionally, since silsesquioxane is modified into the form of SiO₂ during the bonding process and is densely bonded to the surface of the hollow silica, the specific surface area of the resin is reduced due to the SiO₂ formed on the surface of the hollow silica, thereby deteriorating the function of the hollow silica that reduces the refractive index. However, in the silicone resin according to an embodiment of the present invention, a monomer or oligomer capable of forming silsesquioxane (e.g., alkoxysilane) is polymerized together with hollow silica, and thereby a silsesquioxane structure, which includes a hollow silica structure and is simultaneously bonded to the hollow silica structure, is formed. Therefore, there is an effect that additional pores derived from the silsesquioxane structure are formed on the surface of the hollow silica thereby improving the specific surface area of the silicone resin. The increase in the specific surface area of the silicone resin helps form voids within the resin and allows the refractive index of the silicone resin to be lowered. In particular, the specific surface area of the silicone resin can be increased more excellently when the silsesquioxane structure is ladder-shaped, and there appears the effect that the low refractive property is improved due to the ladder-shaped silsesquioxane structure. According to an embodiment of the present invention, the silicone resin having a high specific surface area may have, for example, a Brunauer-Emmett-Teller (BET)-specific surface area of 500 m²/g to 2,000 m²/g. When the specific surface area of the silicone resin is less than 500 m²/g, there may be a problem in that the refractive index of the silicone resin may increase, whereas when the specific surface area of the silicone resin exceeds 2,000 m²/g, there may be a problem in that the cured product of the coating composition containing the silicone resin may have a significant decrease in the mechanical property.

Additionally, the silicone resin according to an embodiment of the present invention includes a hollow silica structure and a silsesquioxane structure bonded to the hollow silica structure, and thus, the silsesquioxane structure supports the hollow silica structure that is relatively weak and easily fragile. Therefore, the coating composition and the cured product to which the silicone resin is applied have the characteristics of high durability and high hardness.

The silicone resin, by including a hollow silica structure therein, allows an excellent low refractive index characteristic to appear through the high porosity of the hollow silica. Specifically, the silicone resin may include 20 wt % to 50 wt % of the hollow silica structure relative to the weight of the silicone resin. When the content of the hollow silica structure is less than 20 wt % of the silicone resin, the effect of reducing the refractive index due to the hollow silica structure may be insignificant, and along with this effect, there may be a problem in that light transmittance may be lowered. Additionally, when the content of the hollow silica structure is more than 50 wt % of the silicone resin, the coatability of the coating composition including the silicone resin may be significantly deteriorated.

The hollow silica structure included in the silicone resin contributes to improving the porosity of the silicone resin, and the porosity of the hollow silica structure included in the silicone resin of the present invention may be, for example, 5 vol % to 80 vol %. When the porosity of the hollow silica structure included in the silicone resin is less than 5 vol %, the decrease in the refractive index of the silicone resin due to the hollow silica structure may be insignificant, whereas when the porosity of the hollow silica structure included in the silicone resin exceeds 80 vol %, there may be a problem in that the mechanical durability of the cured product of the coating composition containing the silicone resin may be lowered. Even within the porosity range of the hollow silica structure, when the porosity of the hollow silica structure included in the silicone resin is in the range of 20 vol % to 70 vol %, the hardness of the cured product of the coating composition containing the silicone resin may be more excellent, whereas when the porosity of the hollow silica structure included in the silicone resin is in the range of 50 vol % to 70 vol %, it may be possible to realize more excellent hardness of the cured product. For example, the porosity of the hollow silica structure may be analyzed using a BET specific surface area analyzer commercially available in the art.

The silicone resin is a polymer formed in a form including a hollow silica structure, and due to the hollow silica structure, the density of the resin may be significantly lowered, and an excellent low refractive property may be secured due to the low density. The density of the silicone resin according to an embodiment of the present invention may be, for example, in the range of 0.5 g/mL to 1.8 g/mL, and may be adjusted by changing the porosity and content of the hollow silica structure. When the density of the silicone resin is less than 0.5 g/mL, there may be a problem in that the coatability and mechanical strength of the coating composition containing the silicone resin may be significantly reduced, whereas when the density of the silicone resin exceeds 1.8 g/mL, the decrease in the refractive index of the coating composition including the silicone resin may be insignificant.

The size of the hollow silica structure included in the inner structure of the silicone resin is defined as the outer diameter of the hollow silica structure, and the size of the hollow silica structure included in the silicone resin is preferably in the range of 10 nm to 500 nm. When the size of the hollow silica structure included in the silicone resin is less than 10 nm, the decrease in refractive index due to the pores of the hollow silica is insignificant, thereby significantly increasing the refractive index of the silicone resin. When the size of the hollow silica structure included in the silicone resin exceeds 500 nm, there may be a problem in that the solution stability of the silicone resin may be significantly decreased due to the large size of the hollow silica structure, and the coatability of the coating composition containing the silicone resin may be significantly decreased.

The silsesquioxane structure may be a polymer including a repeating unit of Formula 1 below, and specifically, the silicone resin may include a structure in which the internal bonding of the polymer including a repeating unit of Formula 1 below is chemically bonded to the surface of the hollow silica structure. The silsesquioxane structure included in the silicone resin of the present invention may include, for example, 1 to 100,000 repeating units of Formula 1 below.

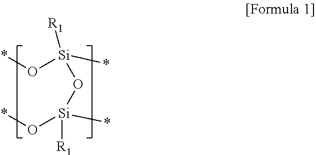

In Formula 1 above, R₁ is each independently a substituted or unsubstituted C₁-C₃₀ alkyl group, a substituted or unsubstituted C₁-C₃₀ aryl group, a fluorine-containing C₁-C₃₀ organic group, an acryl group, a methacryl group, an epoxy group, a cyclohexylepoxy group, a peroxide group, a hydroperoxide group, a thiol group, an isocyanate group, an unsaturated hydrocarbon group, an azide group, an amine group, a carboxyl group, a nitrile group, or a nitro group.

In particular, the silsesquioxane structure may further include a repeating unit of Formula 2 below together with the repeating unit of Formula 1. For example, the silsesquioxane structure may include 1 to 100,000 repeating units of Formula 2 below. When the silsesquioxane structure further includes the repeating unit of Formula 2, the effect of further increasing the dispersibility, solubility, and compatibility of the silicone resin may be achieved.

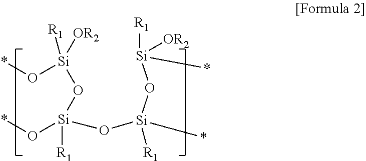

In Formula 2 above, R₁ is each independently a substituted or unsubstituted C₁-C₃₀ alkyl group, a substituted or unsubstituted C₁-C₃₀ aryl group, a fluorine-containing C₁-C₃₀ organic group, an acryl group, a methacryl group, an epoxy group, a cyclohexylepoxy group, a peroxide group, a hydroperoxide group, a thiol group, an isocyanate group, an unsaturated hydrocarbon group, an azide group, an amine group, a carboxyl group, a nitrile group, or a nitro group. R₂ is each independently hydrogen or a substituted or unsubstituted C₁-C₃₀ alkyl group.

In Formulas 1 and 2, the unsaturated hydrocarbon group of R₁ may be a C₁-C₃₀ alkenyl group or a C₁-C₃₀ cycloalkenyl, or the like, and specifically, a vinyl group, a propenyl group, a butenyl group, a cyclopropenyl group, or the like, but is not limited to the above examples.

As in the repeating unit of Formula 1 and the repeating unit of Formula 2, the silsesquioxane structure may not include a hydroxy group within the silsesquioxane structure, and when the silsesquioxane structure does not include a hydroxy group, the hydroxy group content of the silicone resin can be more easily reduced and the solubility for the organic solvent can be improved.

The silicone resin may include one or more curable functional groups selected from a thermosetting functional group and a photocurable functional group, and as a result, the silicone resin may be included in a coating composition to thereby form a cured product through a heat or photocuring process. When hollow silica is simply mixed and bonded to silsesquioxane in a state where silsesquioxane is already polymerized, a curing process is required in the process of binding silsesquioxane and hollow silica. Once the curing process is completed, there are almost no curable functional groups left in quioxane and hollow silica; therefore, an additional curing process may be difficult. However, in the silicone resin according to the embodiment of the present invention, silsesquioxane is bonded to the hollow silica along with polymerization in a state where hollow silica is added in the process of polymerizing the silicone resin, and no separate process is required for chemical bonding in the process of preparing silicone resin; therefore, one or more curable functional groups between a thermosetting functional group and a photocurable functional group may be included in the silsesquioxane structure to a significant degree for curing.

The curable functional group may specifically be included in the silsesquioxane structure in a silicone resin, and may be formed, for example, at the R₁ position of Formulas 1 to 2 among the repeating units of silsesquioxane.

When the curable functional group is included in the silsesquioxane structure, the silsesquioxane structure may include 5 wt % to 40 wt % of the curable functional group relative to the weight of the silsesquioxane structure. When the content of the curable functional group is less than 5 wt % relative to the weight of the silsesquioxane structure included in the silicone resin, there may be a problem in that sufficient curing may not occur through the silicone resin, and thus an additional curing agent may be required when included in the coating composition, and a problem in that the refractive index of the coating composition may increase due to the addition of an additional curing agent. Additionally, when the content of the curable functional group is more than 40 wt % relative to the weight of the silsesquioxane structure included in the silicone resin, the density of the curable functional group in the silicone resin increases, and thus, when the silicone resin is included in the coating composition to form a cured product, there may be a problem in that the physical properties of the cured product may deteriorate because the intra-resin bonding is activated rather than the curing by inter-resin bonding.

The curable functional group may include one or more functional groups among, for example, an acryl group, a methacryl group, an epoxy group, a cyclohexylepoxy group, a peroxide group, a hydroperoxide group, a thiol group, an isocyanate group, an unsaturated hydrocarbon group, an azide group, an amine group, a carboxyl group, a nitrile group, and a nitro group. In particular, the unsaturated hydrocarbon group may be a C₁-C₃₀ aryl group, a C₁-C₃₀ alkenyl group, a C₁-C₃₀ cycloalkenyl group, or the like, and specifically, a phenyl group, a vinyl group, a propenyl group, a butenyl group, a cyclopropenyl group, or the like, but is not limited to these examples.

The silicone resin may not be one formed by the bonding of hollow silica to already polymerized silsesquioxane, and specifically may be one which is polymerized by including a monomer or oligomer capable of forming silsesquioxane (e.g., a monomer or an oligomer derived from alkoxysilane) and hollow silica having a surface functional group. As the alkoxysilane or the oligomer derived from the alkoxysilane is polymerized together with the hollow silica, a silsesquioxane structure to which the hollow silica structure is bonded through the surface functional groups of the hollow silica may be formed, and the hollow silica structure may be included inside the silicone resin in a high proportion.

The silicone resin may be one in which a silsesquioxane structure is bonded to the hollow silica structure through a siloxane bond. It may be in a form where, in the process of polymerization of monomers or oligomers capable of forming a silsesquioxane (e.g., alkoxysilane), hollow silica is also polymerized together with the monomers or oligomers, may be in a form where the surface functional group of hollow silica and silsesquioxane are bonded in the same manner as in the polymerization mechanism of silsesquioxane, and specifically, it may be one where a hollow silica structure and a silsesquioxane structure are siloxane-bonded.

The coating composition according to another embodiment of the present invention includes a solvent together with the silicone resin according to the embodiment of the present invention.

Since the silicone resin included in the coating composition includes a hollow silica structure therein, it can significantly reduce the content of hydroxy groups included in surface functional groups of general hollow silica, and can overcome solvent limitations due to the dispersibility problem of hollow silica. As the solvents, not only polar solvents (e.g., alcohols, ketones, glycols, furans, dimethylformamide, dimethylacetamide, N-methyl-2-pyrrolidone, etc.) which are mainly used as solvents for dispersing hollow silica, but also solvents such as hexane, cyclohexane, cyclohexanone, toluene, xylene, cresol, chloroform, dichlorobenzene, dimethylbenzene, trimethylbenzene, pyridine, methylnaphthalene, nitromethane, acrylonitrile, methylene chloride, octadecylamine, aniline, dimethyl sulfoxide, benzyl alcohol, ethyl nonafluoroisobutyl ether, ethyl nonafluorobutyl ether, perfluorobutylethyl ether, perfluorohexylmethyl ether, or the like may also be used, but the types of solvents are not limited to these examples.

The coating composition overcomes the solvent limitation problem caused by conventional hollow silica and helps to lower the refractive index thereof, but may include a fluorine-based solvent that could not be used due to the compatibility problem with conventional hollow silica. As the fluorine-based solvent, for example, ethyl nonafluoro isobutyl ether, ethyl nonafluoro butyl ether, perfluoro butyl ethyl ether, perfluoro hexyl methyl ether, or the like may be used. When a fluorine-based solvent is used, there is an effect that the refractive index can be further lowered compared to when other solvents are used.

The coating composition may further include hollow silica as needed. In addition to the hollow silica structure included in the silicone resin, the coating composition may further include hollow silica to further increase the proportion of hollow silica, thereby further improving the low refractive index characteristic.

The coating composition may further include a silicone-based additive or an acryl-based additive as needed. As the silicone-based additive, for example, one or more among BYK-300, BYK-301, BYK-302, BYK-331, BYK-335, BYK-306, BYK-330, BYK-341, BYK-344, BYK-307, BYK-333, and BYK-310 may be used, and as the acryl-based additive, one or more among BYK-340, BYK-350, BYK-352, BYK-354, BYK-355, BYK-356, BYK-358N, BYK-359, BYK-361N, BYK-380N, BYK-381, BYK-388, BYK-390, BYK-392, and BYK-394 may be used. When the coating composition includes the silicone-based and/or acryl-based additive, flatness of the surface of the coating film may be further improved.

And the coating composition may further include a dispersion stabilizing additive as needed. As the dispersion stability additive, for example, one or more among DISPERBYK-102, DISPERBYK-108, DISPERBYK-115, DISPERBYK-118, DISPERBYK-140, DISPERBYK-142, DISPERBYK-145, DISPERBYK-160, DISPERBYK-164, DISPERBYK-170, DISPERBYK-174, DISPERBYK-180, DISPERBYK-184, DISPERBYK-191, DISPERBYK-194 N, DISPERBYK-2001, DISPERBYK-2055, DISPERBYK-2117, DISPERBYK-2150, DISPERBYK-2200, ANTI-TERRA-250, BYK-P104, BYK-220S, BYK-154, BYK-9076, and BYK-9077 may be used. When the dispersion stabilizing additive is included, the dispersibility of the hollow silica may be further improved.

A cured product according to another embodiment of the present invention is a cured product of the coating composition.

The cured product may be formed through photocuring or thermal curing of the coating composition.

Since the cured product includes a hollow silica structure therein, it is possible to realize a low refractive index with a high porosity, and specifically, the refractive index of the cured product may be in the range of 1.05 to 1.45, and the refractive index of the cured product may be realized to be in the range of 1.20 to 1.40 by adjusting the composition of the silicone resin.

The cured product may exhibit an excellent low refractive index characteristic by applying a silicone resin including a hollow silica structure. Along with the same, by allowing the silicone resin to include a silsesquioxane structure bonded to the hollow silica structure, it is possible to solve the problem of reduction in the hardness of the cured product that occurs due to the hollowness of conventional hollow silica thereby being able to realize the pencil hardness of the cured product at a level of 2H or harder and realize the pencil hardness of the cured product to 4H or harder by adjusting the composition of the silicone resin. As such, the cured product according to an embodiment of the present invention uses a silicone resin including a hollow silica structure inside the resin structure, thereby solving the problem of lowering the hardness of the existing hollow silica. In particular, the pencil hardness is determined relative to the darkness record of the hardest pencil that does not damage the surface when scratched at a 45° angle by applying a 1 kgf load to a Mitsubishi pencil in accordance with the ASTM D3360 method, and the darkness symbol of a pencil is indicated step by step from the softest hardness of 10B to the highest hardness of 10H.

Hereinafter, the present invention will be described in more detail referring to examples, but the present invention is not limited by the following examples.

### Preparation Example 1: Preparation of Silicone Resin in which Alkoxysilane (Monomer) and Hollow Silica are Polymerized

### Preparation Example 1-1: Preparation of Silicone Resin with Excellent Low Refractive Characteristic

In a dried flask equipped with a cooling tube and a stirrer, 15 g of distilled water and 110 g of tetrahydrofuran were mixed, and the mixture was stirred at a temperature of 4° C. for 30 minutes. Then, 24.64 g (0.1 mol) of 2-(3,4 epoxycyclohexyl) ethyltrimethoxysilane, 56.83 g (0.1 mol) of 1H,1H,2H,2H-perfluorodecyltriethoxysilane, and 10 g of hollow silica (particle size 50 nm, porosity 50 vol %, Sukgyung AT Co., Ltd.) surface-treated with a hydroxy group were added dropwise thereto, and the mixture was stirred for 30 minutes. Thereafter, 5 g of a 0.36 wt % aqueous solution of HCl was very slowly added dropwise to the reaction solution to adjust the pH to have an acidic character, and the mixture was stirred for 1 hour to promote hydrolysis.

While the reaction was being prepared, a 20 wt % aqueous solution of Na₂CO₃ was separately prepared, and 20 g of the same was added dropwise to adjust the pH to have a basic character. Subsequently, the temperature was raised to 25° C., and the mixture was stirred for 5 hours.

The organic solvent layer of the mixture, upon completion of the reaction, was separated and washed with distilled water until the distilled water layer showed a neutral pH, and then the solvent was removed in vacuum under reduced pressure to obtain a silicone resin.

### Preparation Example 1-2: Preparation of Silicone Resin Having Low Refractive Index and High Hardness Characteristics

In a dried flask equipped with a cooling tube and a stirrer, 15 g of distilled water and 110 g of tetrahydrofuran were mixed, and the mixture was stirred at a temperature of 4° C. for 30 minutes. Then, 49.28 g of (0.2 mol) of 2-(3,4 epoxycyclohexyl) ethyltrimethoxysilane and 10 g of hollow silica (particle size 50 nm, porosity 50 vol %, Sukgyung AT Co., Ltd.) surface-treated with a hydroxy group were added dropwise thereto, and the mixture was stirred for 30 minutes. Thereafter, 5 g of a 0.36 wt % aqueous solution of HCl was very slowly added dropwise to the reaction solution to adjust the pH to have an acidic character, and the mixture was stirred for 1 hour to promote hydrolysis.

While the above reaction was being prepared, a 20 wt % aqueous solution of Na₂CO₃ was separately prepared and 20 g of the same was added dropwise to adjust the pH to have a basic character. Subsequently, the temperature was raised to 25° C., and the mixture was stirred for 5 hours.

The organic solvent layer of the mixture, upon completion of the reaction, was separated and washed with distilled water until the distilled water layer showed a neutral pH, and then the solvent was removed in vacuum under reduced pressure to obtain a silicone resin.

### Preparation Example 2: Preparation of Silicone Resin in which Alkoxysilane-Derived Reactant (Oligomer) and Hollow Silica are Polymerized

### Preparation Example 2-1: Preparation of Silicone Resin with Excellent Low Refractive Characteristic

In a dried flask equipped with a cooling tube and a stirrer, 15 g of distilled water and 110 g of tetrahydrofuran were mixed, and the mixture was stirred at room temperature for 30 minutes. Then, 24.64 g (0.1 mol) of 2-(3,4 epoxycyclohexyl)ethyltrimethoxysilane and 56.83 g (0.1 mol) of 1H, 1H,2H,2H-perfluorodecyltriethoxysilane were added dropwise, and the mixture was stirred for 30 minutes to prepare an oligomer.

While the reaction was being prepared, a 20 wt % aqueous solution of Na₂CO₃ was separately prepared, and 5 g of the same was added dropwise. Subsequently, the mixture was stirred for 5 hours. Then, 20 g of a 0.36 wt % aqueous solution of HCl was very slowly added dropwise to the reaction solution to adjust the pH to have an acidic character, and the mixture was stirred at a temperature of 4° C. for 30 minutes. Thereafter, 10 g of hollow silica (particle size 50 nm, porosity 50 vol %, Sukgyung AT Co., Ltd.) surface-treated with a hydroxy group was added dropwise to the reactor at once. Thereafter, a reaction to polymerize the oligomer and the hollow silica was performed at a temperature of 4° C. for 1 day.

The organic solvent layer of the mixture, upon completion of the reaction, was separated and washed with distilled water until the distilled water layer showed a neutral pH, and then the solvent was removed in vacuum under reduced pressure to obtain a silicone resin.

### Preparation Example 2-2: Preparation of Silicone Resin Having Low Refractive Index and High Hardness Characteristics

In a dried flask equipped with a cooling tube and a stirrer, 15 g of distilled water and 110 g of tetrahydrofuran were mixed, and the mixture was stirred at room temperature for 30 minutes. Then, 49.28 g (0.2 mol) of 2-(3,4 epoxycyclohexyl)ethyltrimethoxysilane was added dropwise thereto, and the mixture was stirred for 30 minutes to prepare an oligomer.

While the reaction was being prepared, a 20 wt % aqueous solution of Na₂CO₃ was separately prepared and 5 g of the same was added dropwise. Subsequently, the mixture was stirred for 5 hours. Then, 20 g of a 0.36 wt % aqueous solution of HCl was very slowly added dropwise to the reaction solution to adjust the pH to have an acidic character, and the mixture was stirred at a temperature of 4° C. for 30 minutes. Thereafter, 10 g of hollow silica (particle size 50 nm, porosity 50 vol %, Sukgyung AT Co., Ltd.) surface-treated with a hydroxy group was added dropwise to the reactor at once. Thereafter, a reaction to polymerize the oligomer and the hollow silica was performed at a temperature of 4° C. for 1 day.

The organic solvent layer of the mixture, upon completion of the reaction, was separated and washed with distilled water until the distilled water layer showed a neutral pH, and then the solvent was removed in vacuum under reduced pressure to obtain a silicone resin.

### Preparation Example 3: Preparation of Silicone Resin in which Hollow Silica Content is Adjusted

### Preparation Example 3-1

A silicone resin was prepared in the same manner as in Preparation Example 2-1 above, except that 3 g of hollow silica (particle size 50 nm, porosity 50 vol %, Sukgyung AT Co., Ltd.) surface-treated with a hydroxy group was used.

### Preparation Example 3-2

A silicone resin was prepared in the same manner as in Preparation Example 2-1 above, except that 60 g of hollow silica (particle size 50 nm, porosity 50 vol %, Sukgyung AT Co., Ltd.) surface-treated with a hydroxy group was used.

### Preparation Example 4: Preparation of Silicone Resin in which Size of Hollow Silica is Adjusted

### Preparation Example 4-1

A silicone resin was prepared in the same manner as in Preparation Example 2-1 above, except that hollow silica having a particle size of 8 nm surface-treated with a hydroxy group was used.

### Preparation Example 4-2

A silicone resin was prepared in the same manner as in Preparation Example 2-1 above, except that hollow silica having a particle size of 55 nm surface-treated with a hydroxy group was used.

### Preparation Example 5: Preparation of Silicone Resin n in which Porosity of Hollow Silica is Adjusted

### Preparation Example 5-1

A silicone resin was prepared in the same manner as in Preparation Example 2-1 above, except that hollow silica having a porosity of 3 vol % surface-treated with a hydroxy group was used.

### Preparation Example 5-2

A silicone resin was prepared in the same manner as in Preparation Example 2-1 above, except that hollow silica having a porosity of 75 vol % surface-treated with a hydroxy group was used.

### Preparation Example 5-3

A silicone resin was prepared in the same manner as in Preparation Example 2-1 above, except that hollow silica having a porosity of 85 vol % surface-treated with a hydroxy group was used.

### Preparation Example 6: Preparation of Silicone Resin in which Curable Functional Group Content is Adjusted

### Preparation Example 6-1

A silicone resin was prepared in the same manner as in Preparation Example 2-1 above, except that 4.93 g (0.02 mol) of 2-(3,4 epoxycyclohexyl) ethyltrimethoxysilane, 15.86 g (0.08 mol) of phenyltrimethoxysilane, and 56.83 g (0.1 mol) of 1H, 1H,2H,2H-perfluorodecyltrimethoxysilane were added dropwise, and the mixture was stirred for 30 minutes to prepare an oligomer.

### Preparation Example 6-2

A silicone resin was prepared in the same manner as in Preparation Example 2-1 above, except that 37.0 g (0.15 mol) of 2-(3,4 epoxycyclohexyl) ethyltrimethoxysilane and 28.42 g (0.05 mol) of 1H,1H,2H,2H-perfluorodecyltrimethoxysilane were added dropwise, and the mixture was stirred for 30 minutes to prepare an oligomer.

### Comparative Preparation Examples

### Comparative Preparation Example 1: Preparation of a Mixture of Silsesquioxane and Hollow Silica

In a dried flask equipped with a cooling tube and a stirrer, 15 g of distilled water and 110 g of tetrahydrofuran were mixed, and the mixture was stirred at a temperature of 4° C. for 30 minutes. Then, 24.64 g (0.1 mol) of 2-(3,4 epoxycyclohexyl) ethyltrimethoxysilane and 56.83 g (0.1 mol) of 1H,1H,2H,2H-perfluorodecyltriethoxysilane were added dropwise thereto, and the mixture was stirred for 30 minutes. While the above reaction was being prepared, a 20 wt % aqueous solution of Na₂CO₃ was separately prepared, 20 g of the same was added dropwise thereto to adjust the pH to have a neutral character, and the temperature was raised to 25° C. Subsequently, the mixture was stirred for 5 hours.

The organic solvent layer of the mixture, upon completion of the reaction, was separated, treated with 100 g of an aqueous solution of HCl for one day, and Na₂CO₃ was again added dropwise thereto to change the pH to a neutral pH. Then, the solvent was removed in vacuum under reduced pressure to obtain ladder-type silsesquioxane.

After dissolving 7.5 g of the prepared silsesquioxane in 10 g of ethanol, 2.5 g of hollow silica (particle size 50 nm, porosity 50 vol %, Sukgyung AT Co., Ltd.) surface-treated with a hydroxy group was added dropwise to the reactor at once, and stirred at room temperature for one day to prepare a mixture of silsesquioxane and hollow silica.

### Comparative Preparation Example 2: Preparation of Cured Product of Mixture of Silsesquioxane and Hollow Silica

To 10 g of the mixture prepared in Comparative Preparation Example 1 above was dropwise added 0.2 g of Irgacure 290, as an initiator, to prepare a UV-curable coating composition. The prepared coating composition was coated on soda lime glass to a thickness of 1 μm, dried at 85° C. for 10 minutes, and then irradiated with UV at 1 J/cm² based on A-line to prepare a cured product.

### Comparative Preparation Example 3

A cured product was prepared in the same manner as in Comparative Preparation Example 2 above, except that hollow silica having a porosity of 75 vol % surface-treated with a hydroxy group was used.

### Comparative Preparation Example 4

A silicone resin was prepared in the same manner as in Preparation Example 2-1 above, except that the hollow silica surface-treated with a hydroxy group was not added dropwise to the reactor.

### Experimental Example 1: Measurement of Physical Properties of Silicone Resin

The conditions of the hollow silica used in Preparation Examples 1 to 6 and Comparative Preparation Examples 1 to 4 above and the physical property values of the prepared products were measured in the following manner and the results are shown in Table 1 below.

### (Measurement of Hydroxy Group Content)

The hydroxy group content of the silicone resins or the products prepared in Preparation Examples and Comparative Preparation Examples above was confirmed by area comparison using IR spectroscopy, and it was measured by relative comparison of the Si—OH peak appearing at 3,400 cm⁻¹ to 3,600 cm⁻¹ based on the Si—O—Si being analyzed near 1,100 cm⁻¹.

### (Measurement of Curable Functional Group Content)

The curable functional group content of the silicone resins or the products prepared in Preparation Examples and Comparative Preparation Examples above was analyzed and measured using ¹H-NMR and ¹³C-NMR.

### (Measurement of BET Specific Surface Area)

The BET specific surface area was measured through Brunauer, Emmett, Teller (BET) equipment after adding, into the sample cell, 5 g of each sample, in which solids themselves in the silicone resins or the products prepared in Preparation Examples and Comparative Preparation Examples above or residual solvents are all removed in vacuum under reduced pressure, and nitrogen was used as the adsorption gas.

### (Measurement of Density)

Each sample, in which solids themselves in the silicone resins or the products prepared in Preparation Examples and Comparative Preparation Examples above or residual solvents are all removed in vacuum under reduced pressure, was measured up to 0.1 mg using the Archimedean Buoyancy method.

The compositions of Preparation Examples above and the physical properties of each Preparation Example measured according to the measurement method above are shown in Table 1 below.

TABLE 1

| | | | | Silicone Resin | | | |
|---|---|---|---|---|---|---|---|
| | | | | | | BET | |
| | | | | Content of | Curable | Specific | |
| | Hollow Silica | | | Hydroxy | Functional | Surface | |
| | Content | Size | Porosity | Group | Group | Area | Density |
| | (wt %) | (nm) | (vol %) | (wt %) | (wt %) | (m²/g) | (g/cm³) |
| Preparation | 25 | 50 | 50 | 0.3 | 10 | 800 | 1.20 |
| Example 1-1 | | | | | | | |
| Preparation | 25 | 50 | 50 | 0.2 | 20 | 1200 | 0.90 |
| Example 1-2 | | | | | | | |
| Preparation | 25 | 50 | 50 | 0.2 | 10 | 1200 | 1.15 |
| Example 2-1 | | | | | | | |
| Preparation | 25 | 50 | 50 | 0.3 | 20 | 1600 | 0.85 |
| Example 2-2 | | | | | | | |
| Preparation | 10 | 50 | 50 | 0.4 | 10 | 600 | 1.30 |
| Example 3-1 | | | | | | | |
| Preparation | 55 | 50 | 50 | 0.3 | 10 | 1400 | 1.05 |
| Example 3-2 | | | | | | | |
| Preparation | 25 | 8 | 50 | 0.2 | 10 | 700 | 1.20 |
| Example 4-1 | | | | | | | |
| Preparation | 25 | 550 | 50 | 0.3 | 10 | 900 | 0.95 |
| Example 4-2 | | | | | | | |
| Preparation | 25 | 50 | 3 | 0.5 | 10 | 400 | 1.25 |
| Example 5-1 | | | | | | | |
| Preparation | 25 | 50 | 75 | 0.3 | 10 | 900 | 0.95 |
| Example 5-2 | | | | | | | |
| Preparation | 25 | 50 | 85 | 0.4 | 10 | 1000 | 0.90 |
| Example 5-3 | | | | | | | |
| Preparation | 25 | 50 | 50 | 0.8 | 3 | 1100 | 1.10 |
| Example 6-1 | | | | | | | |
| Preparation | 25 | 50 | 50 | 0.6 | 45 | 1500 | 1.20 |
| Example 6-2 | | | | | | | |
| Comparative | 25 | 50 | 50 | 5.0 | 10 | 400 | 1.15 |
| Preparation | | | | | | | |
| Example 1 | | | | | | | |
| Comparative | 25 | 50 | 50 | 1.3 | 5 | 300 | 1.35 |
| Preparation | | | | | | | |
| Example 2 | | | | | | | |
| Comparative | 25 | 50 | 75 | 1.5 | 10 | 400 | 0.95 |
| Preparation | | | | | | | |
| Example 3 | | | | | | | |
| Comparative | — | — | — | 0.4 | 15 | 50 | 1.35 |
| Preparation | | | | | | | |
| Example 4 | | | | | | | |

Referring to Table 1 above, it can be seen that the silicone resins of the present invention prepared in Preparation Examples 1 to 6 above have a low hydroxy group content by including 1.0 wt % or less of a hydroxy group relative to the total weight of the silicone resin, and in particular, that those prepared in Preparation Examples 1-1 to 5-3 above had a lower hydroxy group content of 0.5 wt % or less. In contrast, it can be seen that the products prepared in Comparative Preparation Examples 1 to 3 above had a hydroxy group content to be as high as 1.3 wt % or more.

In addition, it can be seen that the silicone resins of Preparation Examples 1 to 6 included in the coating composition with a low hydroxy group content, had overall higher BET specific surface area than that of the comparative examples, which affects low refractive properties.

### Preparation Example 7: Preparation of Coating Composition

### Examples 1 to 6: Preparation of Coating Composition

After dissolving 10 g of the silicone resins prepared in Preparation Examples 1 to 6 above in 10 g of ethanol, 0.2 g of Irgacure 290 was added thereto dropwise as a curing initiator to prepare the coating compositions of Examples 1 to 6.

### Example 7: Preparation of Coating Composition

A coating composition was prepared in the same manner as in Example 2-1 above, except that the silicone resin obtained in Preparation Example 2-1 above was used and ethyl nonafluoroisobutyl ether was used as a solvent.

### Comparative Examples 1 to 4: Preparation of Coating Composition

Coating compositions were prepared in the same manner as in Example 2-1, except that the products prepared in Comparative Preparation Examples 1 to 4 were each used instead of the silicone resin.

### Experimental Example 2: Evaluation of Physical Properties of Coating Composition

The physical properties of the coating compositions of Examples 1 to 7 above and Comparative Examples 1 to 4 above were evaluated by the following method and the results are shown in Table 2 below.

### (Evaluation of Dispersity)

The coating compositions of Examples 1 to 7 and Comparative Examples 1 to 4 above were injected into a glass bottle having a diameter of 5 cm and a volume of 100 mL, left at room temperature for one week, and the amount of sediment formed on the bottom was observed. When the amount of sediment covered the entire floor, it was marked with ‘X’, whereas when it covered half thereof, it was marked with ‘Δ’, and when there was no sediment, it was marked with ‘◯’.

### (Evaluation of Coatability)

The coating compositions of Examples 1 to 7 and Comparative Examples 1 to 4 above were applied to a 1 μm-thick PET film (SKC) having a thickness of 50 μm. In the application process, when the coating composition was applied to cover the entire PET film, it was marked with ‘◯’, whereas when it was not partially applied, it was marked with ‘Δ’, and when it flowed down without being applied, it was marked with ‘X’.

### (Evaluation of Presence/Absence of Curing)

In preparing the cured product using the coating compositions of Examples 1 to 7 and Comparative Examples 1 to 4 above by the method of Experimental Example 2 below, when the cured product was prepared without any abnormality, it was marked with ‘◯’, whereas when curing did not proceed normally, and the cured product was not formed, it was marked with ‘X’.

TABLE 2

| | | | Presence/Absence |
|---|---|---|---|
| | Dispersibility | Coatability | of Curing |
| Example 1-1 | ◯ | ◯ | ◯ |
| Example 1-2 | ◯ | ◯ | ◯ |
| Example 2-1 | ◯ | ◯ | ◯ |
| Example 2-2 | ◯ | ◯ | ◯ |
| Example 3-1 | ◯ | ◯ | ◯ |
| Example 3-2 | Δ | ◯ | ◯ |
| Example 4-1 | ◯ | ◯ | ◯ |
| Example 4-2 | Δ | Δ | ◯ |
| Example 5-1 | Δ | ◯ | ◯ |
| Example 5-2 | ◯ | ◯ | ◯ |
| Example 5-3 | ◯ | Δ | ◯ |
| Example 6-1 | ◯ | Δ | ◯ |
| Example 6-2 | ◯ | Δ | ◯ |
| Example 7 | ◯ | ◯ | ◯ |
| Comparative | X | Δ | ◯ |
| Example 1 | | | |
| Comparative | X | Δ | X |
| Example 2 | | | |
| Comparative | X | Δ | X |
| Example 3 | | | |
| Comparative | — | ◯ | ◯ |
| Example 4 | | | |

Referring to Table 2, it can be seen that the dispersibility of the coating compositions of Comparative Examples 1 to 4 above prepared by Comparative Preparation Examples above was significantly reduced, whereas the dispersibility of the coating compositions according to Examples of the present invention was excellent. Additionally, it can be seen that all of the coating compositions according to the embodiments of the present invention were curable and exhibited good coatability.

### Preparation Example 8: Preparation of Cured Product

The coating compositions of Examples 1 to 7 and Comparative Examples 1 to 4 above were each applied to a PET film (SKC), which has a thickness of 50 μm, to a thickness of 1 μm, dried at 85° C. for 10 minutes, and then irradiated with UV at 1 J/cm² to thereby prepare each cured product.

### Experimental Example 3: Evaluation of Physical Properties of Cured Product

### (Evaluation of Refractive Index)

The coating compositions of Examples 1 to 7 and Comparative Examples 1 to 4 above were each coated on a silicon wafer to a thickness of 100 nm, dried at 85° C. for 10 minutes, and then irradiated with UV at 1 J/cm² to thereby prepare each cured film. Using each of the prepared cured films as a specimen, the refractive index was measured using an ellipsometer (SENTECH Co., Ltd.). The measurement was performed in the range of 193 nm to 1,690 nm, and the refractive index value of 550 nm is shown in Table 3 below.

### (Evaluation of Pencil Hardness)

In order to measure the surface hardness of the cured product prepared by the method of Preparation Example 8 above, pencil hardness (Mitsubishi pencil) was measured with a force of 1 kgf. The pencil hardness was written as the result of the darkness record of the hardest pencil that does not damage the surface when a 1 kgf load is applied to a Mitsubishi pencil and scratched at a 45° angle in accordance with the ASTMD 3360 method, and the darkness symbol of a pencil is indicated step by step from the softest hardness of 10B to the highest hardness of 10H. In this evaluation, when the surface is damaged even once among the 5 repeated evaluations, the evaluation is stopped, and the hardness value of the pencil one step lower than the current evaluation of the pencil was shown in Table 3 below.

### (Evaluation of Scratch Resistance)

For the cured product prepared by the method of Preparation Example 8 above, an abrasion test was performed by repeating 2,500 times of Steel wool #0000 at 1 kgf to evaluate scratch resistance, and the degree of scratch was divided into X/weak/medium/strong units and are shown in Table 3 below. In particular, ‘X’ indicates that scratches are not visually recognized, ‘weak’ for less than three large scratches, ‘medium’ for less than 10 large scratches, and ‘strong’ for more than 10 large scratches.

### (Evaluation of Transmittance and Haze)

With respect to the cured product prepared by the method of Preparation Example 8 above, transmittance and haze were measured using COH-400 (Nippon Denshoku Co., Ltd.) in accordance with ISO 14782, and measured 5 times per sample, and the average values are shown in Table 3 below.

TABLE 3

| | Cured Product | | | | |
|---|---|---|---|---|---|
| | Refractive | Pencil | Scratch | Transmittance | |
| Category | Index | Hardness | Degree | (%) | Haze |
| Example 1-1 | 1.25 | 2H | weak | 95 | 0.2 |
| Example 1-2 | 1.30 | 4H | weak | 95 | 0.2 |
| Example 2-1 | 1.20 | 3H | X | 97 | 0.1 |
| Example 2-2 | 1.28 | 4H | X | 96 | 0.1 |
| Example 3-1 | 1.48 | 2H | weak | 91 | 0.4 |
| Example 3-2 | 1.45 | H | weak | 90 | 0.9 |
| Example 4-1 | 1.40 | 2H | weak | 92 | 0.4 |
| Example 4-2 | 1.38 | 2B | medium | 93 | 1.5 |
| Example 5-1 | 1.50 | 2H | weak | 92 | 0.5 |
| Example 5-2 | 1.22 | 3H | X | 97 | 0.1 |
| Example 5-3 | 1.20 | 2B | medium | 94 | 0.6 |
| Example 6-1 | 1.50 | 10B | strong | 90 | 0.6 |
| Example 6-2 | 1.30 | 10B | strong | 90 | 0.4 |
| Example 7 | 1.18 | 4H | X | 97 | 0.1 |
| Comparative | 1.40 | H | strong | 85 | 1.7 |
| Example1 | | | | | |
| Comparative | 1.40 | 5B | strong | 85 | 1.7 |
| Example2 | | | | | |
| Comparative | 1.45 | 8B | strong | 80 | 1.9 |
| Example3 | | | | | |
| Comparative | 1.55 | 4H | X | 91 | 0.5 |
| Example4 | | | | | |

Referring to Table 3, when comprehensively considering the refractive index, transmittance, and haze, it can be seen that the optical properties of the cured products of coating compositions (Examples 1-1 to 7) according to Examples of the present invention above were shown to be superior compared to those of Comparative Examples 1 to 4 above. Additionally, when comprehensively considering the pencil hardness and scratch degree of Table 3, it can be seen that the mechanical durability of the cured product of coating compositions according to Examples of the present invention was shown to be superior to that of Comparative Examples 1 to 4 above. In particular, when considering all the evaluations of refractive index or haze shown in Table 3, it can be seen that the cured product of the coating composition of Example 2-1 exhibited the best physical properties.

Although the preferred embodiments of the present invention have been described in detail above, the scope of the present invention is not limited thereto, and various modifications and improvements that can be made by those skilled in the art using the basic concept of the present invention defined in the following claims according to the present invention also fall within the scope of the rights of the present invention.

What is claimed is:

1. A silicone resin comprising:
a hollow silica structure; and
a silsesquioxane structure bonded to the hollow silica structure,
wherein a hydroxy group is included in an amount of 1.0 wt % or less relative to a total weight of the silicone resin.

2. The silicone resin of claim 1, wherein the silsesquioxane structure is a ladder-type silsesquioxane structure.

3. The silicone resin of claim 1, wherein the silicone resin has a BET specific surface area of 500 m²/g to 2,000 m²/g.

4. The silicone resin of claim 1, wherein the hollow silica structure is included in an amount of 20 wt % to 50 wt % relative to the total weight of the silicone resin.

5. The silicone resin of claim 1, wherein the hollow silica structure has a porosity of 5 vol % to 80 vol %.

6. The silicone resin of claim 1, wherein the silicone resin has a density of 0.5 g/mL to 1.8 g/mL.

7. The silicone resin of claim 1, wherein the hollow silica structure has a size of 10 nm to 500 nm.

8. The silicone resin of claim 1, wherein the silsesquioxane structure comprises a repeating unit of Formula 1 below: 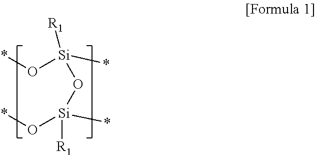
wherein in Formula 1, R₁ is each independently a substituted or unsubstituted C₁-C₃₀ alkyl group, a substituted or unsubstituted C₁-C₃₀ aryl group, a fluorine-containing C₁-C₃₀ organic group, an acryl group, a methacryl group, an epoxy group, a cyclohexylepoxy group, a peroxide group, a hydroperoxide group, a thiol group, an isocyanate group, an unsaturated hydrocarbon group, an azide group, an amine group, a carboxyl group, a nitrile group, or a nitro group.

9. The silicone resin of claim 8, wherein the silsesquioxane structure further comprises a repeating unit represented by Formula 2 below: 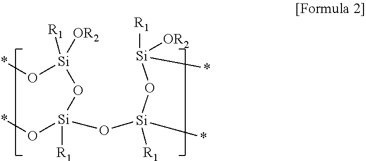
wherein in Formula 2, R₁ is each independently a substituted or unsubstituted C₁-C₃₀ alkyl group, a substituted or unsubstituted C₁-C₃₀ aryl group, a fluorine-containing C₁-C₃₀ organic group, an acryl group, a methacryl group, an epoxy group, a cyclohexylepoxy group, a peroxide group, a hydroperoxide group, a thiol group, an isocyanate group, an unsaturated hydrocarbon group, an azide group, an amine group, a carboxyl group, a nitrile group, or a nitro group, and
R₂ is each independently hydrogen or a substituted or unsubstituted C₁-C₃₀ alkyl group.

10. The silicone resin of claim 1, wherein the silicone resin comprises one or more curable functional groups selected from the group consisting of a thermosetting functional group and a photocurable functional group.

11. The silicone resin of claim 10, wherein the curable functional group is included in the silsesquioxane structure.

12. The silicone resin of claim 11, wherein the silsesquioxane structure comprises 5 wt % to 40 wt % of the curable functional group.

13. The silicone resin of claim 10, wherein the curable functional group comprises one or more functional groups selected from the group consisting of an acryl group, a methacryl group, an epoxy group, a cyclohexylepoxy group, a peroxide group, a hydroperoxide group, a thiol group, an isocyanate group, an unsaturated hydrocarbon group, an azide group, an amine group, a carboxyl group, a nitrile group, and a nitro group.

14. The silicone resin of claim 1, wherein the silicone resin is polymerized by comprising an alkoxysilane or an oligomer derived from an alkoxysilane; and hollow silica having a surface functional group.

15. The silicone resin of claim 1, wherein the hollow silica structure and the silsesquioxane structure are siloxane-bonded.

16. A coating composition comprising the silicone resin of claim 1; and a solvent.

17. The coating composition of claim 16, wherein the solvent comprises a fluorine-based solvent.

18. A cured product of the coating composition of claim 16.

19. The cured product of claim 18, wherein the cured product has a refractive index of 1.05 to 1.45.

20. The cured product of claim 18, wherein the cured product has a pencil hardness of 2H or higher.
